(19) United States
(12) Patent Application Publication
(10) Pub. No.: US 2005/0180625 A1
(43) Pub. Date: Aug. 18, 2005

(54) Image segmenting device and method for segmenting an image with a multiplicity of pixels

(76) Inventors: Arne Heittmann, Munchen (DE); Ulrich Ramacher, Munchen (DE); Jorg Schreiter, Markkleeberg (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/506,208

(22) PCT Filed: Feb. 13, 2003
(86) PCT No.: PCT/DE03/00433

(30) Foreign Application Priority Data
Mar. 1, 2002 (DE) 10209082.3

(51) Int. Cl. G06K 9/62; G06K 9/34

(52) U.S. Cl. 382/159; 382/173

(57) ABSTRACT

Disclosed is an image segmenting device provided with a plurality of pixel pulsed artificial neurons which are coupled to each other via one respective weighted coupling. A weight-modifying unit modifies the weights of the couplings according to the pulse signals of the neurons such that neurons of a segment that is to be formed emit neuron pulse signals in an increasingly synchronous manner.

### BACKGROUND

The invention relates to an image segmenting device and to a method for segmenting an image with a multiplicity of pixels.

In the context of image processing, the robust image segmentation of a recorded image poses a considerable problem particularly in the event of varying ambient conditions in the recording of an image.

In each case for a specific application scenario, it is necessary to develop a proprietary image segmenting method which, on the one hand can be implemented only with difficulty in an application-specific hardware, that is, a specific electrical circuit, and on the other hand yields sufficiently good image segmenting results only on a greatly restricted domain of images, that is, in only a greatly restricted scenario.

The known methods that can be implemented using analog circuit technology and enable image segmenting in real time furthermore have the disadvantage, in particular, that the circuit components of the respective analog circuit have to be implemented with a high precision. As a result, the analog circuits have a large area requirement, which means that such a solution is highly cost-intensive.

Essentially three different principles exist for the segmentation of a digitized image.

In accordance with a first method for segmenting a digitized image, the image segmentation is effected on the basis of the coding information assigned to the respective pixels of the digitized image. For example, see M. Cheriet, J. N. Said, C. Y. Suen, A recursive thresholding technique for image segmentation, IEEE Trans. Image Processing, Vol. 7, pp. 918-921, 1998.

In this connection, coding information is to be understood as any information which is assigned to one or more pixels and characterizes properties of the pixel, in particular brightness values (luminance values) or color values (chrominance values) assigned to one or more pixels.

In accordance with the second principle, described for example in D. German, S. German, C. Graffigne, P. Dong, Boundary detection by constrained optimization, IEEE Trans. Pattern Anal. Mach. Intell., Vol. 12, pp. 609-628, 1990, the image segmentation is effected on the basis of edges that are contained in the digital image and are determined in the context of this method.

The region-based image segmentation described in R. Adam, L. Bishof, Seeded region growing, IEEE Trans. Patter Anal. Mach. Intell., Vol. 16, pp. 641-647, 1994, as the third principle is, just like the methods described above, unsuitable for implementation in a specific electrical circuit in a manner exhibiting real time capability, on account of its sequential processing structure.

John G. Harris, Ghristof Koch, Jin Luo, A Two-Dimensional Analog VLSI Circuit for Detecting Discontinuities in Early Vision, Science, Vol. 248, pp. 1029-1211, June 1990, describes so-called resistive fuses, in the case of which a nonlinear signal diffusion leads to spatial signal smoothing and to detection of discontinuities that are interpreted as segment boundaries.

Principles concerning so-called pulsed artificial neural neurons and pulsed neural networks formed therefrom are described in connection with the segmentation of audio signals in M. A. Glover, A. Hamilton, L. S. Smith, An Analog VLSI Integrate-And-Fire Neural Network for Sound Segmentation, May 21, 1998.

A VLSI current mode chip (very large scale integration) that forms a pulsed synapse of a pulsed artificial neuron is presented in D. J. Mayes, A. Hamilton, J. E. Louvet, A VLSI Current Mode Synapse Chip, Proceedings of the International Workshop on Artificial Neural Networks, Malaga, Spain, pp. 815-821, 1995.

Further B. L. Dokic, CMOS Schmitt-Trigger, Proceedings of the IEEE, Vol. 131, No. 5, pp. 197-202, October 1984, describes a realization of a Schmitt trigger.

D. Jung, der Vergleich von plastischen Synapsen gegenüber Synapsen mit konstantem Gewicht in spikenden neuronalen Netzen, [comparing plastic synapses in relation to synapses with constant weight in spiking neural networks], dissertation at the Technical University of Berlin, Institute for Microelectronics, available on Feb. 27, 2002 on the Internet at the address: http://mikro.ee.tu-berlin.de/-spinnsoc/pdf/sp2inn_jung_diplomathesis.pdf describes the application of pulsed neurons for image segmentation.

DE 100 50 062 describes an arrangement for determining the position of an object in an image and also a method for training the arrangement.

The arrangement that serves for object recognition in accordance with DE 100 50 062 is based on a trained artificial neural network with pulsed neurons. Predefined image elements are provided, which are characterized by means of features assigned to the image elements. A plurality of neuron layers are provided for each feature, which neuron layers in each case describe the existence of the respective feature. Each neuron layer is formed by a column of a plurality of pulsed artificial neurons. Within each neuron layer, the neurons respectively contained therein are completely combined with one another, the couplings being assigned weights. Furthermore, a synchronization element is provided, which is used to code target feature values of the target object which is presented to the arrangement in a training phase and whose features are known and stored. In the context of the training method, the weights are adapted and the neurons are thus synchronized between the neurons assigned to the image element and the target feature values. Neuron layers that determine the area of attention within the image are synchronized with the synchronization element.

M. Schäfer and G. Hartmann, A Flexible Hardware Architecture for Online Hebbian Learning in the Sender-Oriented PCNN-Neurocomputer Spike 128K, Proceedings of International Conference on Microelectronics for Neural, Fuzzy and Bio-Inspired Systems, pages 316 to 323, 1999; U. Roth et al, Hebbian On-Line Learning for Spike-Processing Neural Networks, TU Berlin, Institute for Microelectronics, Internal Report 11/95, available on Nov. 18, 2002 on the Internet at the address: http://mikro.ee.tu-berlin.de/-spinnsoc/pubs.html; and B. M. Wilamowski and Y. Ota, CMOS Architecture of Synchronous Pulse-Coupled Neural Network and Its Application to Image Processing, 26th Annual Conference of the IEEE Industrial Electronics Society, Vol. 2, pages 1213 to 1218, 2000, describe various learning methods for training a pulsed artificial neural network.

### SUMMARY

One embodiment of the invention provides a method for segmenting an image with a multiplicity of pixels and also a corresponding image segmenting device.

One embodiment of an image segmenting device for segmenting an image having a multiplicity of pixels which are in each case assigned an item of coding information into a plurality of image segments has a multiplicity of pulsed artificial neurons, a pulsed artificial neuron in each case being assigned to a pixel.

In this connection, coding information is to be understood as an item of information that is assigned to one or more pixels and characterizes the latter, for example a brightness value (luminance information) or color value (chrominance information) assigned to the pixel or pixels.

The pulsed artificial neurons may be assigned to a plurality of different pixels. As an alternative, it is provided that a plurality of pixels are assigned to an artificial neuron. In one embodiment, precisely one pulsed artificial neuron is in each case provided for precisely one pixel and assigned thereto.

The pulsed artificial neurons are in each case coupled at least to a portion of adjacent pulsed artificial neurons, preferably directly adjacent pulsed artificial neurons, via in each case a weighted coupling.

A weighted coupling is to be understood as an electrical coupling in which an electrical signal passed via said coupling, for example an electric current, is multiplied by, generally amplified with, a weight value, also referred to as weight hereinafter.

Each pulsed artificial neuron is set up in such a way that it can be output a neuron pulse signal dependent on the coding information which is assigned to the pixel to which the pulsed artificial neuron is assigned, as the corresponding output signal of the pulsed artificial neuron.

Furthermore, the image segmenting device has at least one weight altering device that is set up in such a way that it can alter the weights of the couplings in a manner dependent on the neuron pulse signals in such a way that pulsed artificial neurons of an image segment to be formed in each case output neuron pulse signals that are increasingly synchronous with one another.

By means of an image segmenting unit that is likewise provided in the image segmenting device that is set up in such a way that the pixels from these assigned pulsed artificial neurons are jointly segmented to form an image segment, which output neuron pulse signals that are sufficiently synchronous with one another with regard to a predetermined criterion, the pixels are segmented to form image segments in accordance with the pulse behavior of the respective pulsed artificial neurons that are assigned to the pixels to be classified, that is, pixels to be segmented.

In one embodiment of a method for segmenting an image with a multiplicity of pixels which are in each case assigned coding information into a plurality of image segments, a multiplicity of pulsed artificial neurons being provided, a pulsed artificial neuron in each case being assigned to a pixel, and the pulsed artificial neurons in each case being coupled at least to a portion of adjacent pulsed artificial neurons via in each case an, for example, electrically conductive, coupling, each pulsed artificial neuron outputs a neuron pulse signal dependent on the coding information which is assigned to the pixel to which the pulsed artificial neuron is assigned.

Depending on the neuron pulse signals, the weights assigned to the couplings are altered in such a way that pulsed artificial neurons of an image segment to be formed in each case output neuron pulse signals that are increasingly synchronous with one another. The pixels from these assigned pulsed artificial neurons are jointly segmented to form an image segment, which output neuron pulse signals that are sufficiently synchronous with one another with regard to a predetermined criterion.

A predetermined criterion is to be understood, by way of example, to be an arbitrary threshold value criterion, relative or absolute, which describes the similarity of the synchronous behavior in the outputting of the neuron pulse signals from the respective pulsed artificial neurons.

The threshold value may be prescribed as desired in a manner dependent on the application.

In this connection, a pulsed artificial neuron is to be understood as a fundamentally arbitrary signal generator for pulse generation which outputs an output signal in a manner dependent on input signals, integrated with respect to time via inputs of the signal generator, when the integration value is exceeded.

One example of a pulsed artificial neuron that is used is a so-called integrate-and-fire neuron, as is described in M. A. Glover, A. Hamilton, L. S. Smith, An Analog VLSI Integrate-And-Fire Neural Network for Sound Segmentation, May 21, 1998.

As an alternative, it is also possible to use the pulsed neurons described in D. Jung, der Vergleich von plastischen Synapsen gegenüber Synapsen mit konstantem Gewicht in spikenden neuronalen Netzen, [comparing plastic synapses in relation to synapses with constant weight in spiking neural networks], dissertation at the Technical University of Berlin, Institute for Microelectronics, available on Feb. 27, 2002 on the Internet at the address: http://mikro.ee.tu-berlin.de/-spinnsoc/pdf/sp2inn_jung_diplomathesis.pdf with the multipliers at the respective inputs of the pulsed artificial neuron.

In one embodiment of the invention, the image segmentation is effected by virtue of associated image areas being marked locally by means of pulse patterns by the signal generators assigned to the image segments, that is, the pulsed artificial neurons assigned to the image segments, for the purpose of pulse generation, outputting signal pulses temporally synchronously and periodically.

In this case, each pixel is assigned a pulse generator (signal generator) that generates signal pulses with constant duration and amplitudes of a pulse frequency dependent on the brightness value assigned to the respective pixel, generally the coding information assigned to the pixel.

In addition, with respect to the signal generators that are locally adjacent to one another, their exists a coupling such that, upon emission of a signal pulse of a signal generator adjacent to the respective signal generator, the pulse frequency is increased in a manner dependent on the coupling strength, that is, the coupling weights described below.

The local coupling of the individual signal generators has the effect that the signal generators are in each case synchronized, that is, output signal pulses in equilibrium with the same pulse frequency are classified as associated with the same image segment. The signal generators that generate signal pulses with a different pulse frequency are associated with different image segments or are grouped into different image segments, that is, segmented.

One embodiment of the invention introduces adaptable, or variable connecting weights for the coupling of the pulsed artificial neurons, the adaptation of the weights being realized exclusively by locally available signals from a pulsed artificial transmitter neuron and a pulsed artificial receiver neuron with a data-driven self-organization process.

Very good and robust image segmenting results are achieved on account of the adaptation of the weights between the pulsed artificial neurons in such a way that pulsed artificial neurons of an image segment to be formed in each case output neuron pulse signals increasingly synchronously with one another.

The device according to one embodiment of the invention and the method serve for extraction of an image, the extraction being effected in a self-organizing manner. According to one embodiment of the invention, a learning phase is no longer necessary since the pulsed neurons are synchronized with one another and not with regard, for example, to a synchronization element.

The dynamic characteristics of the pulsed artificial neurons are used for extraction of image objects. This means that, in a self-organizing process, the neurons which are assigned to mutually similar pixels relative to the coding information fire increasingly synchronously, so that they form an object “of their own accord”.

The procedure according to one embodiment of the invention therefore does not constitute a training of weights, but rather an adaptation of weights directly to the content of the image respectively fed.

In accordance with one embodiment of the invention, the image segmenting device is configured as an electrical circuit, for example, as an electrical analog circuit.

Configuring the image segmenting device as an analog circuit enables real-time segmentation of an image.

As an alternative, the invention may be realized in software, that is, in the form of a computer program that is executed by a microprocessor.

In accordance with another embodiment of the invention, the weight altering device is set up in such a way that a weight is altered in accordance with the following equation while a first neuron L of the two neurons that are coupled to one another by means of the coupling is in a signal transmission state and a second neuron K is in a signal reception state:

$$\frac{ⅆ}{ⅆ t} {W}_{KL} = - γ \cdot {W}_{KL} + {μ}_{1} \cdot ( {a}_{K} - {B}_{0} ) , 0 < {B}_{0} < Θ ,$$

where
W_{KL} denotes the weight assigned to the coupling between the first neuron L and the second neuron K,
γ denotes a predetermined relaxation parameter,
μ₁ denotes a predetermined second synchronization parameter,
a_{L} denotes the membrane potential of the first neuron L,
a_{K} denotes the membrane potential of the second neuron K.

In accordance with another embodiment of the invention, the weight altering device is set up in such a way that a weight is altered in accordance with the following equation while the two neurons, a first neuron L and a second neuron K, that are coupled to one another by means of the coupling are in a signal reception state:

$$\frac{ⅆ}{ⅆ t} {W}_{KL} = - γ \cdot {W}_{KL} + {μ}_{0} \cdot ( {a}_{L} - {a}_{K} ) ,$$

where
W_{KL} denotes the weight assigned to the coupling between the first neuron L and the second neuron K,
γ denotes a predetermined relaxation parameter,
μ₀ denotes a predetermined first synchronization parameter,
a_{L} denotes the membrane potential of the first neuron L,
a_{K} denotes the membrane potential of the second neuron K.

For both of the embodiments described above, it may be provided that the weight altering device or the individual weight altering units is/are set up in such a way that the weight is altered in all the cases not respectively described above in accordance with the following equation:

$$\frac{ⅆ}{ⅆ t} {W}_{KL} = - γ \cdot {W}_{KL} .$$

It has been shown in experiments that the above-described adaptation variants for altering or for adapting the weights between two respective pulsed artificial neurons lead to an additional improvement of the segmentation result.

In accordance with another embodiment of the invention, it is provided that each pixel is assigned in each case precisely one pulsed artificial neuron.

This embodiment of the invention is distinguished in particular by its simplicity and thus by the fact that it is capable of being realized more simply and more cost-effectively.

The weight altering device may have a multiplicity of weight altering units, a weight altering unit in each case being provided per coupling between a first pulsed artificial neuron and a second pulsed artificial neuron of the multiplicity of pulsed artificial neurons and being assigned thereto.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a sketch of a detail from CMOS image sensors, pixels assigned to the CMOS image sensors and pulsed artificial neurons assigned to the pixels in accordance with an exemplary embodiment of the invention.

FIG. 2 illustrates an illustration of the local networking structure between the pulsed artificial neurons in accordance with an exemplary embodiment of the invention.

FIG. 3 illutrates a sketch of two pulsed artificial neurons that are coupled to one another, and of the function blocks of an adaptable multiplier, also referred to as weight amplifier hereinafter, and a weight altering unit in accordance with an exemplary embodiment of the invention.

FIG. 4 illustrates a schematic sketch of the voltage profile of the membrane potentials and of the output signal, that is, of the neuron pulse signal in accordance with a pulsed artificial neuron according to the invention.

FIG. 5 illustrates a more detailed sketch of the function blocks from FIG. 3 in accordance with a first exemplary embodiment of the invention.

FIG. 6 illustrates a more detailed sketch of the function blocks from FIG. 3 in accordance with a second exemplary embodiment of the invention.

FIG. 7 illustrates an electrical circuit describing the soma of the pulsed artificial neurons according to the invention.

FIG. 8 illustrates an electrical circuit of a Schmitt trigger used according to the invention.

FIG. 9 illustrates a sketch of a realization of the weight amplifier from FIG. 3 in accordance with an exemplary embodiment of the invention.

FIG. 10 illustrates an electrical circuit of a weight amplifier circuit in accordance with FIG. 9.

FIG. 11 illustrates an electrical circuit of a weight altering unit.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

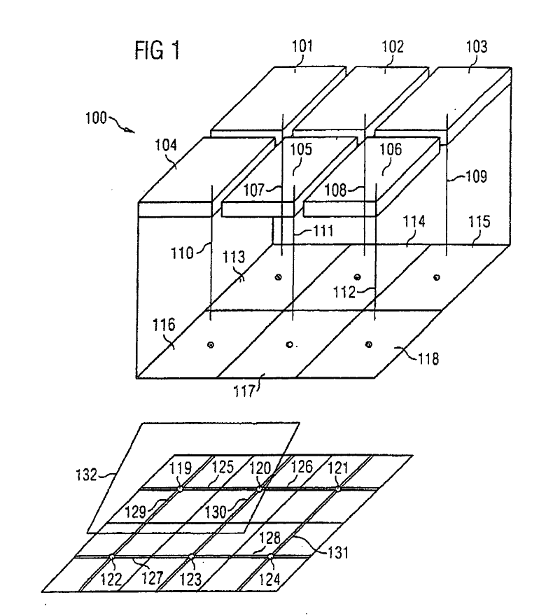

FIG. 1 illustrates a digital camera 100 in accordance with an exemplary embodiment of the invention.

In accordance with the exemplary embodiment of the invention, the camera 100 has 1024*768 CMOS image sensors 101, 102, 103, 104, 105, 106 that are set up for detecting light impinging on the CMOS image sensor 101, 102, 103, 104, 105, 106 and for outputting a respective brightness signal 107, 108, 109, 110, 111, 112 that in each case has a value dependent on the respective intensity of the light impinging on the image sensor 101, 102, 103, 104, 105, 106.

A brightness signal 107, 108, 109, 110, 111, 112 is in each case assigned to precisely one pixel 113, 114, 115, 116, 117, 118; to put it another way, a pixel 113, 114, 115, 116, 117, 118 is assigned to precisely one image sensor 101, 102, 103, 104, 105, 106.

For each pixel 113, 114, 115, 116, 117, 118, in each case precisely one pulsed artificial neuron 119, 120, 121, 122, 123, 124, explained in more detail below, is provided and is in each case assigned to precisely one pixel and coupled to in each case an output of the respective image sensor 101, 102, 103, 104, 105, 106 at which the corresponding brightness signal 107, 108, 109, 110, 111, 112 is provided.

As will be explained in more detail below, the respective brightness value signal 107, 108, 109, 110, 111, 112 is fed to the respective pulsed artificial neuron 119, 120, 121, 122, 123, 124 as input signal via an input coupling of the respective pulsed artificial neuron 119, 120, 121, 122, 123, 124.

The behavior of the pulsed artificial neurons 119, 120, 121, 122, 123, 124 and also the invention's alteration of the weights that are assigned to the couplings 125, 126, 127, 128, 129, 130, 131 are explained in more detail below.

The pulsed artificial neurons that are in each case directly adjacent to one another are coupled to one another via bidirectional signal couplings, that is, either a bidirectional coupling or two couplings arranged next to one another, that is, electrically conductive structures, 125, 126, 127, 128, 129, 130, 131, so that a signal exchange is possible locally from a first pulsed artificial neuron to a second pulsed artificial neuron arranged directly adjacent thereto.

In accordance with this exemplary embodiment of the invention, the pulsed artificial neurons that are directly adjacent to one another are in each case coupled to one another in a row or in a column.

As an alternative, it is readily possible also to provide diagonal couplings between two pulsed artificial neurons arranged in different columns and rows.

Furthermore, an image segmenting unit (not illustrated) is provided. The first output and optionally additionally the second output of each pulsed artificial neuron 119, 120, 121, 122, 123, 124 is coupled to an input of the image segmenting unit, so that all the neuron pulse signals are fed to the image segmenting unit.

The image segmenting unit receives and analyzes the neuron pulse signals with regard to their temporal behavior, that is, with regard to the frequency with which the respective neuron pulse signal is emitted and/or with regard to the time duration of the neuron pulse signal.

The image segmenting unit groups the pixels in a manner dependent on the temporal behavior of the neuron pulse signals assigned to them to form image segments, pixels whose pulsed artificial neurons 119, 120, 121, 122, 123, 124 have a transmission behavior (firing behavior) that is sufficiently similar to one another, clearly a sufficiently similar temporal behavior, being grouped to form a respective image segment.

The similarity criterion depending on which the image segmenting unit groups, that is, segments, the pulsed artificial neurons 119, 120, 121, 122, 123, 124 and thus the pixels is dependent on the application.

This means that the tolerance range around an exactly synchronous temporal behavior of the pulsed artificial neurons 119, 120, 121, 122, 123, 124 that are grouped to form a segment is to be chosen in a manner dependent on the application.

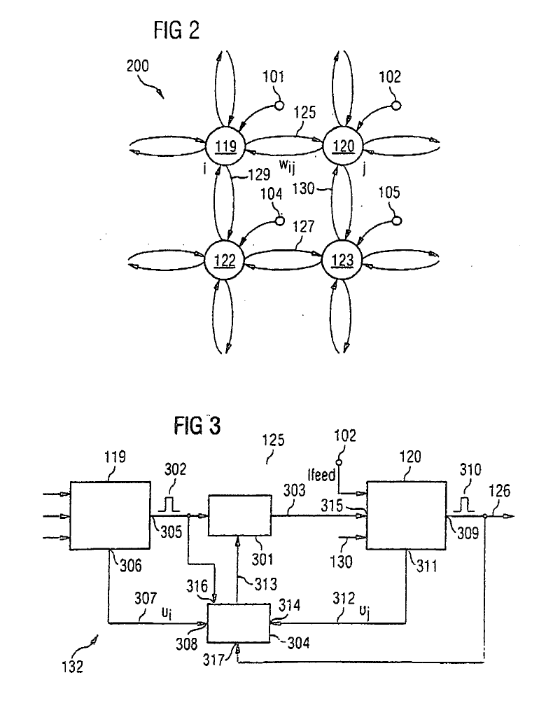

FIG. 2 once again illustrates, for illustration purposes, the connecting structure 200 of the pulsed artificial neurons 119, 120, 122, 123 coupled to one another from FIG. 1.

The pulsed artificial neurons 119, 120, 121, 123 are coupled to one another via two electrical lines as bidirectional couplings 125, 127, 129, 130, each coupling 125, 127, 129, 130 in each case being assigned a weight value by which an electrical signal passed via the respective coupling 125, 127, 129, 130 is multiplied before it is fed to the input of the pulsed artificial neuron 119, 120, 122, 123 that receives the electrical signal.

To put it another way, this means that, for the case where a first pulsed artificial neuron functions as a transmitter neuron and thus emits an electrical signal, this emitted signal is passed via an electrical line as coupling to a second pulsed artificial neuron functioning as a receiver neuron, the electrical signal being multiplied by the weight value respectively assigned to the coupling.

Furthermore, FIG. 2 illustrates the respective coupling to the corresponding output of the image sensor 101, 102, 104, 105 respectively assigned to the pulsed artificial neuron 119, 120, 122, 123, which image sensor 101, 102, 104, 105, feeds a corresponding brightness value in the form of an electric current to the respective pulsed artificial neuron 119, 120, 122, 123.

FIG. 3 illustrates a detail 132 from FIG. 1 with a first pulsed artificial neuron 119 and a second pulsed artificial neuron 120, which are coupled to one another via an electrical coupling 125, a weight amplifier 301, the structure of which is explained in more detail below, being provided in the electrical coupling 125.

The neuron pulse signal 302 supplied by the first pulsed artificial neuron 119 as output signal of the first pulsed artificial neuron 119 is thus fed to the weight amplifier 301, multiplied there by the weight value W_{KL} assigned to the electrical coupling 125, and passed as weighted neuron pulse signal 303 to an input 315 of the second pulsed artificial neuron 120.

Furthermore, both the first pulsed artificial neuron 119 and the second pulsed artificial neuron 120 are coupled to a weight altering unit 304 in accordance with this exemplary embodiment of the invention.

The neuron pulse signal 302 is output via the first output 305 of the first pulsed artificial neuron 119 and the latter's present value of the membrane potential 307 is fed to a first input 308 of the weight altering unit 304 via a second output 306 of the first pulsed artificial neuron 119. The first output 305 is furthermore coupled to a third input 316 of the weight altering unit 304, so that the neuron pulse signal of the first pulsed artificial neuron 119 can be fed to the weight altering unit 304.

In a corresponding manner, if appropriate, the neuron pulse signal 310 of the second pulsed artificial neuron 120 is output via a first output 309 of the second pulsed artificial neuron 120 and the value of the membrane potential 312 of the second pulsed artificial neuron 120 is output via a second output 311, and is fed to a second input 314 of the weight altering unit 304. The first output 309 is furthermore coupled to a fourth input 317 of the weight altering unit 304, so that the neuron pulse signal of the second pulsed artificial neuron 120 can be fed to the weight altering unit 304.

The aim of this circuit is that, for similar currents I_{feed}, that is, for mutually similar brightness signals, the neuron pulse signals at the respective first outputs 306, 309 of the pulsed artificial neurons are synchronized with one another, that is, that a neuron pulse signal is output from the respective pulsed artificial neurons 119, 120 essentially at identical or very similar instants.

The weight W_{KL} of a coupling is variable and is altered by means of the respective weight altering unit 304 by way of a weight altering signal 313.

As will be explained in more detail below, the change of the weight W_{KL} is dependent on the electrical voltages U_{L} and U_{K} across the capacitances of the respectively adjacent soma, that is, the respectively adjacent pulsed artificial neurons 119, 120.

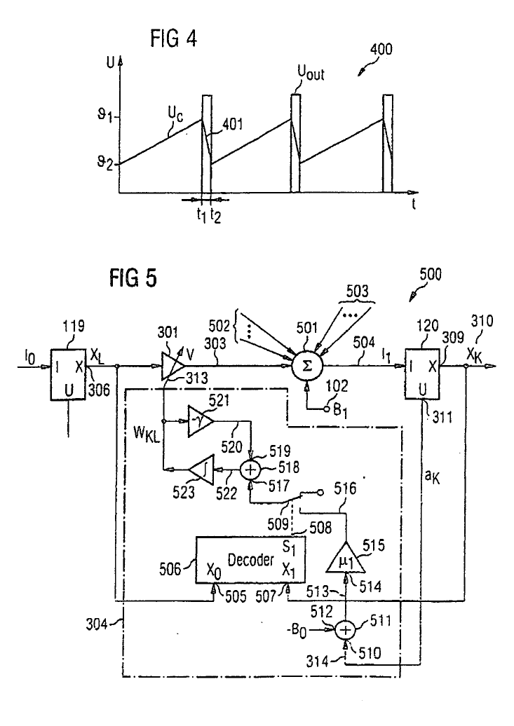

FIG. 4 illustrates, in a diagram 400, the switching behavior of a pulsed artificial neuron 119, 120, 121, 122, 123, 124 in accordance with this exemplary embodiment of the invention.

In accordance with this exemplary embodiment, an integrate-and-fire neuron is in each case used as pulsed artificial neuron 119, 120, 121, 122, 123, 124, which has a membrane potential which, modeled by means of a capacitor, has a continuously increasing capacitor voltage U_{C} until a first threshold value θ₁ is reached at a first switching instant t₁.

If the first threshold value θ₁ is reached, then a neuron pulse signal 401 is emitted for a pulse duration of (t₂−t₁) until a second instant t₂, whereby the electrical potential across the capacitor is returned to a second threshold value θ₂.

Starting from the second instant t₂ at which the capacitor potential corresponding to the membrane potential of the pulsed artificial neuron has fallen to the second threshold value θ₂, a renewed integration of the input signals present at the inputs of the respective pulsed artificial neuron is effected.

The corresponding behavior described in connection with FIG. 4 is continuously and permanently repeated.

The profile of the membrane potential that is illustrated symbolically in FIG. 4 usually does not rise linearly in practice, but rather depends on the electrical signals present at the inputs of the respective pulsed artificial neuron, but is generally a monotonically rising function.

As an alternative, a relaxation factor may be provided, by means of which, over a relatively long time duration, the membrane potential of the respective pulsed artificial neuron is reduced with a relaxation factor.

FIG. 5 illustrates, in a first block diagram 500, a realization of the weight altering unit 304 from FIG. 3 in accordance with a first exemplary embodiment of the invention.

In accordance with this exemplary embodiment of the invention, the respective pulsed artificial neuron 119, 120, on the input side, integrates the so-called synaptic current to form a membrane potential a_{K} and a_{L}, respectively.

As soon as the membrane potential a_{K}, a_{L} reaches a predetermined first threshold value θ₁, the respective pulsed artificial neuron 119, 120 emits a neuron pulse signal of defined length.

Afterward, once the neuron pulse signal 401 has been emitted in the manner described above, the membrane potential a_{K}, a_{L} is reduced to a quiescent potential value and the integration starts anew.

The synaptic current is composed additively of the weighted local gray-scale value signal, that is, the brightness signal, and the neuron pulse signals of the directly adjacent pulsed artificial neurons that are weighted with the couplings.

A weight W_{KL} is altered by means of a weight altering signal 313 that is output from the weight altering unit 304 and to the weight amplifier 301 and which describes the temporal change of the weight W_{KL}.

The weight altering signal of a local weight W_{KL} depends exclusively on the local signals for the representation of the membrane potentials a_{K}, a_{L} from the respective transmitter neuron, to put it another way from the respective pulsed artificial neuron, which emits a neuron pulse signal and the receiver neuron, that is, the pulsed artificial neuron that receives the respective neuron pulse signal, and the signal transmission state and signal reception state, respectively, of the transmitter neuron and the receiver neuron.

In accordance with the variant for altering the weight value W_{KL} as illustrated in FIG. 5, an adaptation, that is, an alteration of the weight value W_{KL} is effected for the case where the first pulsed artificial neuron 119 having the index L transmits a neuron pulse signal and the second pulsed artificial neuron 120 having the index K receives the neuron pulse signal in accordance with the following equation:

$$\frac{ⅆ}{ⅆ t} {W}_{KL} = - γ \cdot {W}_{KL} + {μ}_{1} \cdot ( {a}_{K} - {B}_{0} ) , 0 < {B}_{0} < Θ ,$$

where
W_{KL} denotes the weight assigned to the coupling between the first neuron L and the second neuron K,
γ denotes a predetermined relaxation parameter,
μ₁ denotes a predetermined second synchronization parameter,
a_{L} denotes the membrane potential of the first neuron L,
a_{K} denotes the membrane potential of the second neuron K.

At all other points in time, that is, at the instants at which the first pulsed artificial neuron 119 is not in a signal transmission state and/or the second pulsed artificial neuron 120 is not in a signal reception state, the weight W_{KL} is altered in accordance with the following equation:

$$\frac{ⅆ}{ⅆ t} {W}_{KL} = - γ \cdot {W}_{KL} .$$

This procedure for altering the weight W_{KL} may be described in such a way that the weight value W_{KL}, depending on the membrane potential a_{K} of the pulsed artificial neuron 120 that receives the neuron pulse signal (the second pulsed artificial neuron 120 in accordance with FIG. 5), is prevented depending on how far away the membrane potential a_{K} is from the first threshold value, that is, the switching threshold of the second pulsed artificial neuron 120.

Consequently, in accordance with this exemplary embodiment, for the receiver neuron, a first offset value, preferably half the value of the first threshold value θ₁, that is,

$$\frac{{θ}_{1}}{2} ,$$

is subtracted from the present membrane potential a_{K} and the difference is multiplied by the predetermined second synchronization parameter μ₁ and the product is added to a weight W_{KL} multiplied by a negative relaxation parameter −γ, a value of one volt being used for the first threshold value θ₁ and a value of 0.1±(0.1 to 0.2)×0.1 being used for the relaxation parameter y in accordance with this exemplary embodiment.

This procedure clearly corresponds to a positive feedback of the neuron pulse signal that is output by the first pulsed artificial neuron 119, depending on the actual membrane potential a_{K} of the second pulsed artificial neuron 120.

The pulsed artificial neurons 119, 120 illustrated in the block diagram 500 are constructed in the manner described in M. A. Glover, A. Hamilton, L. S. Smith, An Analog VLSI Integrate-And-Fire Neural Network for Sound Segmentation, May 21, 1998.

The VLSI circuit illustrated in the block diagram 500 furthermore has a summation node 501, by means of which the weighted neuron pulse signals of other pulsed artificial neurons 502, continuous unpulsed signals 503 and a second offset signal B₁, which corresponds to the brightness signal of the image sensor 102 assigned to the second pulsed artificial neuron 120 and has a temporally constant signal level, are summed and forwarded as synaptic current 504 to the second pulsed artificial neuron 120, which is referred to as the receiver neuron 120 hereinafter.

During the reception phase of the integrate-and-fire neurons, the incoming synaptic current 504 is in each case integrated temporally with respect to the respective membrane potential a_{K}.

If the membrane potential aₖ exceeds the predetermined first threshold value θ₁, then, as described above, a neuron pulse signal with a constant signal level is emitted for a predetermined time duration.

Afterward, the membrane potential is reset to the signal level “0” and the integration is started anew.

During the time interval in which the neuron pulse signal is emitted, the signal integration of the input signal for the respective pulsed artificial neuron 119, 120 is interrupted.

The first output 306 of the first pulsed artificial neuron 119, which is referred to as the transmitter neuron 119 hereinafter, is coupled to a first input 505 of a decoder 506, the second input 507 of which is coupled to the first output 309 of the receiver neuron 120.

In the decoder 506, the neuron pulse signal X_{L} from the transmitter neuron 119 is logically ANDed with the negated neuron pulse signal \overline{xₖ} 320 present at the first output 309 of the receiver neuron 120.

The signal formed by ANDing is provided at an output 508 of the decoder 506 and serves as a control signal for a switch 509.

The membrane potential a_{K} of the receiver neuron 120 is fed via the second output 311 of the receiver neuron 120 to a first input 510 of a first adder 511, to whose second input 512 the first offset signal B₀ in negated form is fed.

The difference as formed by the first adder 511 is fed as difference signal 513 to an input 514 of a first multiplier 515, by means of which the difference signal 513 is multiplied by the first synchronization parameter μ₁, and the product 516 is applied to the input of the switch 509, which is controlled by the output signal of the decoder 506 via a control input.

If the switch 509 is closed, which is effected for the case where the transmitter neuron 119 outputs a neuron pulse signal X_{L} and is thus in a signal transmission state and the receiver neuron 120 does not output a neuron pulse signal x_{K} and is thus in a signal reception state, then the product signal 516 is fed to a first input 517 of a second adder 518, to whose second input 519 is applied a feedback value 520 formed from a weight value W_{KL} multiplied by the negative value of the relaxation parameter γ in a relaxation multiplier 521. The summation signal 522 formed by the second adder is fed to an integrator 523 and integrated with respect to time by means of the latter.

The output signal of the integrator 523 corresponds to the weight W_{KL} that is provided for that of the coupling 125 between the transmitter neuron 119 and receiver neuron 120. The weight value W_{KL} is fed as weight altering signal 313 to the multiplier 301, that is, the weight amplifier 301.

It should be noted that, in accordance with this exemplary embodiment, the realization is designed for a current addition.

As an alternative, provision is made of a potential addition for forming the synaptic current 504, in which case the addition node 501 would have to be replaced by a correspondingly adapted electrical circuit.

In accordance with this exemplary embodiment, the weight amplifier 301 is configured as a pulse synaptic multiplier, as described in D. J. Mayes, A. Hamilton, J. E. Louvet, A VLSI Current Mode Synapse Chip, Proceedings of the International Workshop on Artificial Neural Networks, Malaga, Spain, pp. 815-821, 1995.

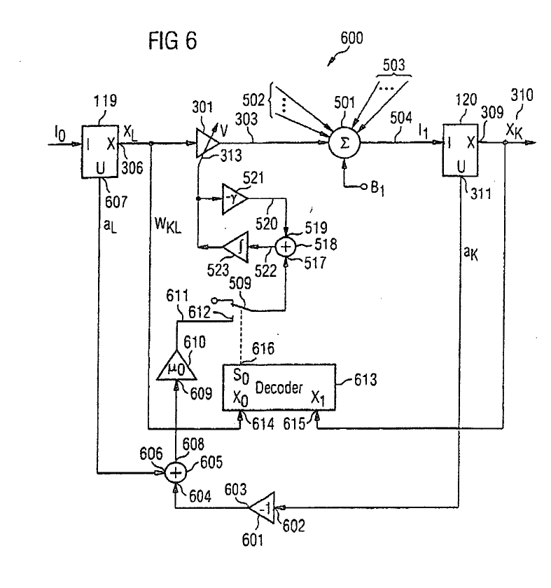

FIG. 6 illustrates, in a second block diagram 600, an alternative embodiment of the weight altering unit 304.

In accordance with this configuration of the invention, the weight W_{KL} is altered in the time period in which the transmitter neuron 119 is in a signal reception state and the receiver neuron 120 is also in a signal reception state, that is, to put it another way, in a time period in which none of the two pulsed artificial neurons 119, 120 emits a neuron pulse signal, in accordance with the following equation:

$$\frac{ⅆ}{ⅆ t} {W}_{KL} = - γ \cdot {W}_{KL} + {μ}_{0} \cdot ( {a}_{L} - {a}_{K} ) ,$$

where
W_{KL} denotes the weight assigned to the coupling between the first neuron L and the second neuron K,
γ denotes a predetermined relaxation parameter,
μ₀ denotes a predetermined first synchronization parameter,
a_{L} denotes the membrane potential of the first neuron L,
a_{K} denotes the membrane potential of the second neuron K.

In all other scenarios, that is, for the case where the transmitter neuron 119 and/or the receiver neuron 120 are/is in a signal transmission state, that is, emit/emits a neuron pulse signal, then the weight W_{KL} is altered in accordance with the following equation:

$$\frac{ⅆ}{ⅆ t} {W}_{KL} = - γ \cdot {W}_{KL} .$$

This procedure corresponds to moving near or approximating, to the two membrane potentials a_{K} and a_{L}.

The circuit 600 in accordance with this exemplary embodiment of the invention differs from the circuit 500 described in FIG. 5 in particular by the fact that the second output 311 of the receiver neuron 120 is coupled to an input 602 of an inverter 601, the output 603 of which is coupled to a first input 604 of a first adder 605, the second input 606 of which is coupled to the second output 607 of the transmitter neuron 119.

The output 608 of the first adder 605 is coupled to an input 609 of a first multiplier 610, by means of which the difference between the membrane potential a_{L} of the transmitter neuron 119 and the membrane potential a_{K} of the receiver neuron 120 is multiplied by the first synchronization parameter μ₀ 610 and fed as product signal 611 to an input 612 of switch 509.

Furthermore, the circuit 600 in accordance with the second exemplary embodiment differs from the circuit 500 in accordance with the first exemplary embodiment in the fact that the decoder 613 is set up in such a way that it provides the output signal, present at the output 616 of the decoder 613, from the neuron pulse signal x_{L}, present at the first input 614 of the decoder 613 in negated form, by logical ANDing with the negated value of the output signal x_{K} of the receiver neuron 120, present at the second input 615 of the decoder 613.

The construction and the interconnection of the remaining components of the circuit 600 correspond to those of the circuit 500 in accordance with the first exemplary embodiment as illustrated in FIG. 5.

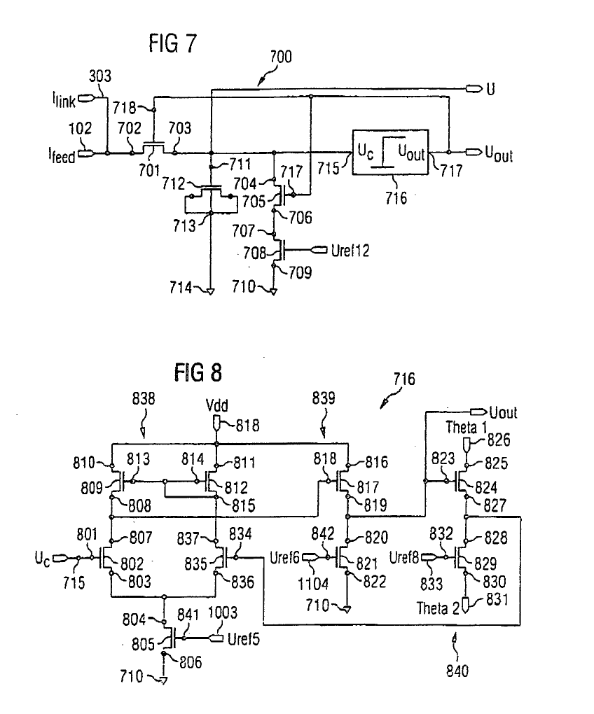

FIG. 7 illustrates an electrical circuit 700 that forms the pulsed artificial neuron 119, 120, 121, 122, 123, 124 in accordance with this exemplary embodiment of the invention.

The electrical circuit has a first PMOS field-effect transistor 701, the first source/drain terminal 702 of which is coupled on the one hand to the respective output of the image sensor and on the other hand to the respective coupling to the adjacent pulsed artificial neurons.

A second source/drain terminal 703 of the first PMOS field-effect transistor 701 is coupled to a first source/drain terminal 704 of a first NMOS field-effect transistor 705, the second source/drain terminal 706 of which is coupled to a first source/drain terminal 707 of a second NMOS field-effect transistor 708, the second source/drain terminal 709 of which is coupled to the ground potential 710.

The source/drain terminal 703 of the first PMOS field-effect transistor 701 is furthermore coupled to a transistor 712 operating as a capacitor, the further terminals 713 of which are coupled to the ground potential 714.

The second source/drain terminal 703 of the first PMOS field-effect transistor 701 is furthermore coupled to an input 715 of a Schmitt trigger 716, the structure of which will be explained in more detail below, the output 717 of which is coupled to the output of the pulsed artificial neuron.

The output 717 of the Schmitt trigger 716 is furthermore fed back to the gate terminal 718 of the first PMOS field-effect transistor 701 and to the gate terminal 719 of the first NMOS field-effect transistor 705.

The first PMOS field-effect transistor 701, the first NMOS field-effect transistor 705 serve as switches.

If a signal pulse occurs at the output 717 of the Schmitt trigger 716, then the first PMOS field-effect transistor 701 interrupts the current flow that is provided via the electrical coupling 303 or from the image sensor 102.

At the same time, the first NMOS field-effect transistor 705 switches on the current that is provided via the from the second NMOS field-effect transistor 708 as constant-current source and discharges the transistor 712 operating as a capacitor.

The electrical voltage across the transistor 712 operating as a capacitor is fed to the input 715 of the Schmitt trigger 716.

FIG. 8 illustrates the structure of the Schmitt trigger 716 in detail. The input 715 is coupled to the gate terminal 801 of a third NMOS field-effect transistor 802, the first source/drain terminal 803 of which is coupled to a first source/drain terminal 804 of a fourth NMOS field-effect transistor 805, the second source/drain terminal 806 of which is coupled to the ground potential 710.

A second source/drain terminal 807 of the third NMOS field-effect transistor 802 is coupled to a first source/drain terminal 808 of a second PMOS field-effect transistor 809, the second source/drain terminal 810 of which is coupled to a first source/drain terminal 811 of a third PMOS field-effect transistor 812.

Furthermore, the gate terminals 813 of the second PMOS field-effect transistor 809 and the gate terminal 814 of the third PMOS field-effect transistor 812 and also a second source/drain terminal 815 of the third PMOS field-effect transistor 812 are coupled to one another.

Furthermore, the second source/drain terminal 810 of the second PMOS field-effect transistor 809 and the first source/drain terminal 811 of the third PMOS field-effect transistor 812 are coupled to a first source/drain terminal 816 of a fourth PMOS field-effect transistor 817 and also to the operating voltage 818.

The gate terminal 818 of the fourth PMOS field-effect transistor 817 is coupled to the first source/drain terminal 808 of the second PMOS field-effect transistor 809 and also to the second source/drain terminal 807 of the third NMOS field-effect transistor 802.

A second source/drain terminal 819 of the fourth PMOS field-effect transistor 817 is coupled on the one hand to a first source/drain terminal 820 of a fifth NMOS field-effect transistor 821, the second source/drain terminal 822 of which is coupled to the ground potential 710.

Furthermore, the second source/drain terminal 819 of the fourth PMOS field-effect transistor 817 is coupled to the gate terminal 823 of a fifth PMOS field-effect transistor 824, the first source/drain terminal 825 of which is coupled to a first terminal 826.

A second source/drain terminal 827 of the fifth PMOS field-effect transistor 824 is furthermore coupled to a first source/drain terminal 828 of a sixth NMOS field-effect transistor 829, the second source/drain terminal 830 of which is coupled to a second terminal 831 and the gate terminal 832 of which is coupled to a third terminal 833.

Furthermore, the second source/drain terminal 827 of the fifth PMOS field-effect transistor 824 and the first source/drain terminal 828 of the sixth NMOS field-effect transistor 829 are coupled to the gate terminal 834 of a seventh NMOS field-effect transistor 835, the first source/drain terminal 836 of which is coupled to the first source/drain terminal 803 of the third NMOS field-effect transistor 802 and to the first source/drain terminal 804 of the fourth NMOS field-effect transistor 805.

The second source/drain terminal 837 of the seventh NMOS field-effect transistor 835 is furthermore coupled to the second source/drain terminal 815 of the third PMOS field-effect transistor 812.

The Schmitt trigger 716 thus has a differential amplifier 838 and also a first inverter 839 and a second inverter 840.

The differential amplifier 838, which operates together with the downstream first inverter 839 as a so-called OTA (operational transconductance amplifier), compares the voltage U_{C}—present at the input 715 of the Schmitt trigger 716—of the transistor 712 operating as a capacitor with the threshold values θ₁ and θ₂ present at the first terminal 826 and the second terminal 831.

The threshold values θ₁ and θ₂ are thus designed using the second inverter 840.

By virtue of the feedback from the second inverter 840 to the positive input of the differential amplifier 838, the circuit described above operates as a Schmitt trigger 716.

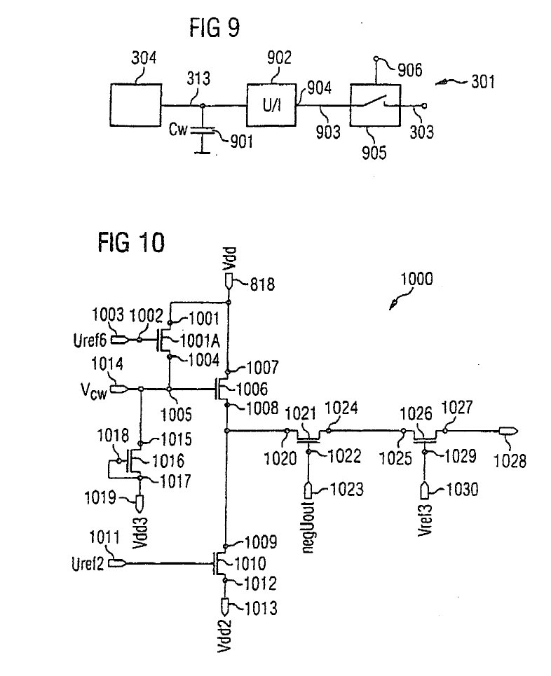

FIG. 9 illustrates a block diagram of the weight amplifier 301.

A capacitor 901 having the capacitance C_{W} serves as the actual weight storage element.

The change of the weight W_{KL} is effected by means of the current provided by the weight altering unit 304 from I_{W}_{_{KL}} which is provided as the weight altering signal 313.

The voltage across the capacitor 901 is converted into an electric current 903 by means of a voltage/current converter 902 and, for the case where a switch 905 connected to the output 904 of the voltage/current converter 902 is closed, that is, for the case where a high level is present at a fourth terminal 906, is switched through to the coupling as neuron pulse signal 303.

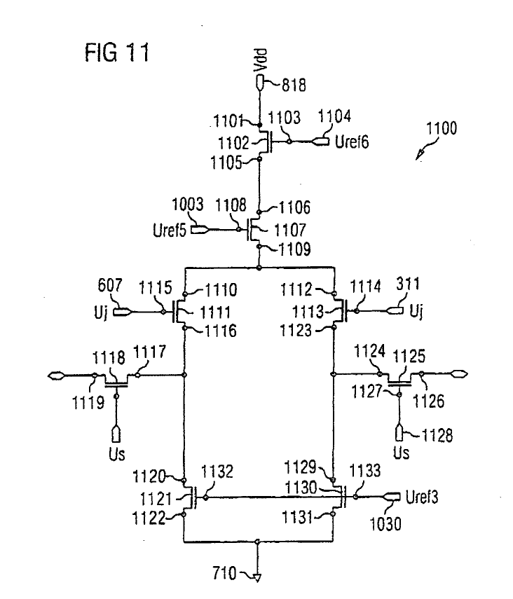

FIG. 10 illustrates a circuit 1000 that realizes the weight amplifier 301.

A first source/drain terminal 1001 of a sixth PMOS field-effect transistor 1001A is coupled to the operating potential 818, the gate terminal 1002 of which transistor is coupled to a fifth terminal 1003 and, via the latter, to the gate terminal 841 of the fourth NMOS transistor 805 in FIG. 8.

A second source/drain terminal 1004 of the sixth PMOS field-effect transistor 1001A is coupled to the gate terminal 1005 of a seventh PMOS field-effect transistor 1006, the first source/drain terminal 1007 of which is coupled to the first source/drain terminal 1001 of the sixth PMOS transistor 1002.

The sixth PMOS field-effect transistor 1001A clearly forms the second multiplier 521.

A second source/drain terminal 1008 of the seventh PMOS field-effect transistor 1006 is coupled to a first source/drain terminal 1009 of an eighth PMOS transistor 1010, the gate terminal of which is coupled to a sixth terminal 1011.

A second source/drain terminal 1012 of the eighth PMOS transistor 1010 is coupled to a second operating potential 1013.

Furthermore, the gate terminal 1005 of the seventh PMOS transistor 1006 is coupled to a seventh terminal 1014, and also to a first source/drain terminal 1015 of a ninth PMOS field-effect transistor 1016.

A second source/drain terminal 1017 of the ninth PMOS field-effect transistor 1016 is coupled to the gate terminal 1018 thereof and also to a third operating potential 1019.

Furthermore, the second source/drain terminal 1008 of the seventh PMOS transistor 1006 is coupled to a first source/drain terminal 1020 of a tenth PMOS field-effect transistor 1021, the gate terminal 1022 of which is coupled to an eighth terminal 1023 and the second source/drain terminal 1024 of which is coupled to a first source/drain terminal 1025 of an eleventh PMOS field-effect transistor 1026, the second source/drain terminal 1027 of which is coupled to a ninth terminal 1028 and the gate terminal 1029 of which is coupled to a tenth terminal 1030.

The ninth PMOS field-effect transistor 1016 clearly serves as a limitation of the operating range of the circuit 1000 illustrated in FIG. 10.

It should be noted in this connection that the eleventh PMOS field-effect transistor 1026, the eighth PMOS field-effect transistor 1010 and also the seventh PMOS field-effect transistor 1006 are operated in a range in which they have an exponential characteristic curve.

FIG. 11 illustrates an electrical circuit 1100 that forms the weight altering unit 304.

A first source/drain terminal 1101 of a twelfth PMOS field-effect transistor 1102 is coupled to the operating potential 818, the gate terminal 1103 of which transistor is coupled to an eleventh terminal 1104 and, via the latter, to the gate terminal 842 of the fifth NMOS field-effect transistor 821.

A second source/drain terminal 1105 of the twelfth PMOS field-effect transistor 1102 is coupled to a first source/drain terminal 1106 of a thirteenth PMOS field-effect transistor 1107, the gate terminal 1108 of which is coupled to the fifth terminal 1003.

A second source/drain terminal 1109 of the thirteenth PMOS field-effect transistor 1107 is coupled to a first source/drain terminal 1110 of a fourteenth PMOS field-effect transistor 1111 and also to a first source/drain terminal 1112 of a fifteenth PMOS field-effect transistor 1113, the gate terminal 1114 of which is coupled to the second output 311 of the receiver neuron 120.

The gate terminal 1115 of the fourteenth PMOS field-effect transistor 1111 is coupled to the second output terminal 607 of the transmitter neuron 119. A second source/drain terminal 1116 of the fourteenth PMOS field-effect transistor 1111 is coupled to a first source/drain terminal 1117 of an eighth NMOS field-effect transistor 1118, that the second source/drain terminal 1119 of which the weight altering signal 313 is provided for setting the weight of the coupling between the transmitter neuron 119 and the receiver neuron 120.

Furthermore, the second source/drain terminal 1116 of the fourteenth PMOS field-effect transistor 1111 is coupled to a first source/drain terminal 1120 of a ninth NMOS field-effect transistor 1121 and, via the second source/drain terminal 1122 thereof, to the ground potential 710.

A second source/drain terminal 1123 of the fifteenth PMOS field-effect transistor 1113 is coupled to a first source/drain terminal 1124 of a tenth NMOS field-effect transistor 1125, at the second source/drain terminal 1126 of which the weight altering signal 313 is provided for setting the weight of the coupling between the receiver neuron 120 and the transmitter neuron 119.

The gate terminal 1127 of the tenth NMOS field-effect transistor 1125 is furthermore coupled to a twelfth terminal 1128.

The second source/drain terminal 1123 of the fifteenth PMOS field-effect transistor 1113 is furthermore coupled to a first source/drain terminal 1129 of an eleventh NMOS field-effect transistor 1130 and, via the second source/drain terminal 1131 thereof, to the ground potential 710.

The gate terminals 1132 and 1133 of the ninth NMOS field-effect transistor 1121 and of the eleventh NMOS field-effect transistor 1130 are coupled to the tenth terminal 1030 and, via the latter, to the gate terminal 1029 of the eleventh PMOS field-effect transistor 1026.

The twelfth PMOS field-effect transistor 1102 and the thirteenth PMOS field-effect transistor 1107 supply a constant current.

One embodiment of the invention provides a system of internetworked pulsed artificial neurons in which information is represented by pulse patterns and in which associated image segments are marked by synchronization of corresponding neuron pulses by means of alterations of the coupling weights.

In particular, a weight is altered during the reception phase of the two neurons that are coupled to one another by means of the coupling, and the altering signal being dependent on the values of the membrane potentials in such a way that the coupling weight is increased in the event of a significantly large positive signal difference in the membrane potential of the transmitter neuron and the receiver neuron and the weight for the coupling is decreased in the event of a significantly large negative signal difference.

As an alternative, the alteration of a coupling weight may be provided during the reception phase of the receiver neuron and the transmission phase of the transmitter neuron and in this case the adaptation signal depends on the membrane potential of the receiver neuron in such a way that the weight for the coupling is decreased for significantly small values of the membrane potential and the weight of the coupling is increased for significantly large values of the membrane potential.

Although specific embodiments have been illustrated and described herein, it will be appreciated by those of ordinary skill in the art that a variety of alternate and/or equivalent implementations may be substituted for the specific embodiments shown and described without departing from the scope of the present invention. For example, the functional circuit 52, 54, 56, and 58 of FIG. 4 are illustrated with logic circuits that one skilled in the art will recognize can be implemented in many various configurations while still achieving the objects of the present invention. This application is intended to cover any adaptations or variations of the specific embodiments discussed herein. Therefore, it is intended that this invention be limited only by the claims and the equivalents thereof.

1-10. (canceled)

11. An image segmenting device for segmenting an image with a multiplicity of pixels, which are each assigned coding information, into a plurality of image segments, the image segmenting device comprising:
a multiplicity of pulsed artificial neurons, each pulsed artificial neuron being assigned to a pixel;
wherein each of the pulsed artificial neurons are coupled at least to a portion of adjacent pulsed artificial neurons via a weighted coupling;
wherein each pulsed artificial neuron is configured such that it can output a neuron pulse signal dependent on the coding information that is assigned to the pixel to which the pulsed artificial neuron is assigned;
at least one weight altering device that is configured to alter the weights of the weighted couplings in a manner dependent on the neuron pulse signals such that pulsed artificial neurons of an image segment to be formed in each case output neuron pulse signals that are increasingly synchronous with one another; and
an image segmenting unit that is configured such that it segments pixels from the assigned pulsed artificial neurons jointly to form an image segment, which output neuron pulse signals that are sufficiently synchronous with one another with regard to a predetermined criterion.

12. The image segmenting device of claim 11, set up as an electrical circuit.

13. The image segmenting device of claim 12, set up as an electrical analog circuit.

14. The image segmenting device of claim 11, wherein each pixel is assigned in each case precisely one pulsed artificial neuron.

15. The image segmenting device of claim 11, wherein the weight altering device is a multiplicity of weight altering units, a weight altering unit in each case being provided per coupling between a first pulsed artificial neuron and a second pulsed artificial neuron of the multiplicity of pulsed artificial neurons.

16. The image segmenting device of claim 11, wherein the weight altering device is configured such that a weight is altered in accordance with the following equation while the two neurons, a first neuron L and a second neuron K, that are coupled to one another by means of the coupling are in a signal reception state:
$$\frac{ⅆ}{ⅆ t} {W}_{KL} = - γ \cdot {W}_{KL} + {μ}_{0} \cdot ( {a}_{L} - {a}_{K} ) ,$$
where
W_{KL} denotes the weight assigned to the coupling between the first neuron L and the second neuron K,
γ denotes a predetermined relaxation parameter,
μ₀ denotes a predetermined first synchronization parameter,
a_{L} denotes the membrane potential of the first neuron L,
a_{K} denotes the membrane potential of the second neuron K.

17. The image segmenting device of claim 16, wherein the weight altering device is set up in such a way that the weight is otherwise altered in accordance with the following equation:
$$\frac{ⅆ}{ⅆ t} {W}_{KL} = - γ \cdot {W}_{KL} .$$

18. The image segmenting device of claim 11, wherein the weight altering device is set up in such a way that a weight is altered in accordance with the following equation while a first neuron L of the two neurons that are coupled to one another by means of the coupling is in a signal transmission state and a second neuron K is in a signal reception state:
$$\frac{ⅆ}{ⅆ t} {W}_{KL} = - γ \cdot {W}_{KL} + {μ}_{1} \cdot ( {a}_{K} - {B}_{0} ) , 0 < {B}_{0} < Θ ,$$
where
W_{KL} denotes the weight assigned to the coupling between the first neuron L and the second neuron K,
γ denotes a predetermined relaxation parameter,
μ₁ denotes a predetermined second synchronization parameter,
a_{L} denotes the membrane potential of the first neuron L,
a_{K} denotes the membrane potential of the second neuron K.

19. The image segmenting device of claim 18, wherein the weight altering device is set up in such a way that the weight is otherwise altered in accordance with the following equation:
$$\frac{ⅆ}{ⅆ t} {W}_{KL} = - γ \cdot {W}_{KL} .$$

20. A method for segmenting an image with a multiplicity of pixels, which are each assigned coding information, into a plurality of image segments, the method comprising:
providing a multiplicity of pulsed artificial neurons, each pulsed artificial neuron being assigned to a pixel;
coupling each of the pulsed artificial neurons to a portion of adjacent pulsed artificial neurons via a weighted coupling;
wherein each pulsed artificial neuron outputs a neuron pulse signal dependent on the coding information that is assigned to the pixel to which the pulsed artificial neuron is assigned;
altering the weights of the weighted couplings in a manner dependent on the neuron pulse signals such that pulsed artificial neurons of a segment to be formed in each case output neuron pulse signals that are increasingly synchronous with one another; and
jointly segmenting the pixels from the assigned pulsed artificial neurons to form an image segment, which output neuron pulse signals that are sufficiently synchronous with one another with regard to a predetermined criterion

21. The method of claim 20, wherein the method is implemented in an electrical circuit.

22. The method of claim 21, wherein the method is implemented in an analog electrical circuit.

23. The method of claim 20 further including assigning each pixel to precisely one pulsed artificial neuron.

24. The method of claim 20, wherein altering the weights is accomplished by a multiplicity of weight altering units, each provided per coupling between a first pulsed artificial neuron and a second pulsed artificial neuron.

25. An image segmenting device for segmenting an image having multiple pixels into a plurality of image segments, comprising:
multiple pulsed artificial neurons, wherein each pulsed artificial neuron is assigned to a pixel and each pixel is assigned coding information;
a weighted coupling that couple each of the pulsed artificial neurons to a portion of adjacent pulsed artificial neurons;
a neuron pulse signal output from at least some of the multiple pulsed artificial neurons, the neuron pulse signal dependent on the coding information assigned to the pixel assigned to the pulsed artificial neuron;
a weight altering device configured to alter weights of the weighted coupling based on the neuron pulse signals so that pulsed artificial neurons of an image segment to be formed output neuron pulse signals that are increasing synchronous with one another; and
an image segmenting unit configured to segment pixels from the assigned pulsed artificial neurons jointly to form an image segment.

26. The image segmenting device of claim 25, wherein the image segmenting unit outputs neuron pulse signals that are sufficiently synchronous with one another with regard to a predetermined criteria.

27. The image segmenting device of claim 25, set up as an electrical circuit.

28. The image segmenting device of claim 27, set up as an electrical analog circuit.

29. The image segmenting device of claim 25, wherein each pixel is assigned in each case precisely one pulsed artificial neuron.

30. The image segmenting device of claim 25, wherein the weight altering device is a multiplicity of weight altering units, a weight altering unit in each case being provided per coupling between a first pulsed artificial neuron and a second pulsed artificial neuron of the multiplicity of pulsed artificial neurons.
